(19) United States
(12) Patent Application Publication
(10) Pub. No.: US 2011/0320208 A1
(43) Pub. Date: Dec. 29, 2011

(54) Page identification method for audio book

(76) Inventor: Ki Kin Wong, Corte Madera, CA (US)

(21) Appl. No.: 12/803,305

(22) Filed: Jun. 24, 2010

(51) Int. Cl. G10L 21/00

(52) U.S. Cl. 704/270; 704/E21.001

(57) ABSTRACT

A page identification method for audio book with a main housing, a plurality of pages, a plurality of light blocking panels, an audio record and playback electronic circuit including microphone, speaker, power source, record switch and playback switch, a microprocessor and a plurality of light sensing devices. The top surface of the main body has a plurality of apertures. Each light sensing device located directly under each main body aperture. Each page has one or more apertures that are aligned with at least one of the main body apertures. Each light blocking panel is interleaved between each page so that when the page is turned by the user the light blocking panel will slide over to cover or uncover the page aperture causing the light sensing devices to send a signal to the microprocessor that tells the audio circuit which message to play for each page.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of electronic audio books and more specifically to a page identification method for an audio book.

The supplementation of an audio message with a standard graphic book page is well known. Numerous story books now exist that contain the necessary audio electronic circuits where the user presses one of a series of buttons to play an audio message for a corresponding page of graphic images.

Many electronic audio books allow the user to match up a specific audio message with a specific page by using an electronic pen which can send a control signal which it presses on a sensing switch on the surface of the main body of the book.

However, there is a deficiency in the prior technology in that the current method of pen sensing is complicated and time consuming to construct thereby driving up the price of such and audio book and increasing the possibility of breakdown due to complexity of construction. This category of audio story book is very price sensitive with respect to volume of retail sales. Additionally, retailers do not want to deal with return orders due to breakdown of electronic components.

### BRIEF SUMMARY OF THE INVENTION

The primary object of the invention is to provide a page identification method for an audio story book that is inexpensive to manufacture and easy to use, and has a high reliability level.

Another object of the invention is to provide a page identification method that allows a message to be automatically played for a particular page without needing to press a specific button for that page.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed page identification method for audio book comprising: a main rectilinear housing, a plurality of rigid pages, a plurality of light blocking panels, a standard audio record and playback electronic circuit including microphone, speaker, power source, record switch and playback switch. The invention also includes a microprocessor and a plurality of light sensing devices, the top surface of said main body having a plurality of apertures, each said light sensing device located directly under each said main body apertures, each said page having one or more apertures, each said page hingedly attached in standard book form to said main body, each said page having at least one aperture that is aligned with at least one of said main body apertures, each light blocking panel interleaved between each page, each light blocking panel affixed on one edge to the underside of each said page so that when said page is turned by said user said light blocking panel will slide over to cover or uncover said page aperture, and said covering and uncovering of said page apertures causing said light sensing devices to send a signal to trigger switches within said microprocessor producing a binary coded signal that tells said audio circuit which message to play for each said page.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic view of the electronic portion of the invention.

FIG. 2 is a perspective view of the invention with pages opened and single flap light blocking panel.

FIG. 3 is a perspective view of the invention with pages opened and a light blocking panel that includes an aperture.

FIG. 4 is a partial section view of the light aperture portion of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

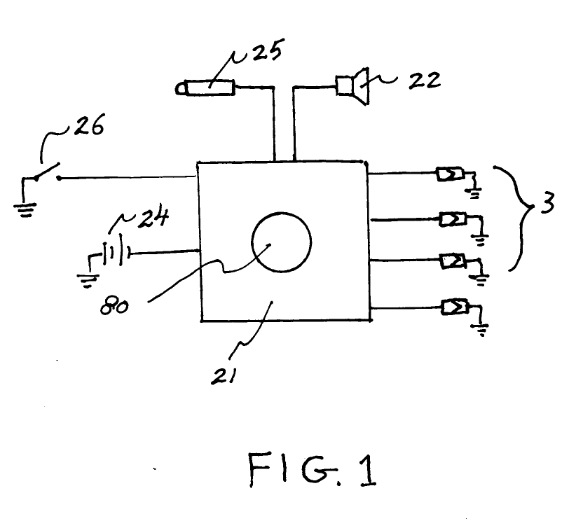

Referring now to FIG. 1 we see a schematic view of the electronic circuit of the present invention. A printed circuit board 21 includes a microprocessor 80 which can process signals received from trigger switches 3. Standard audio components including speaker 22, microphone 25, battery 24 and playback switch 26 act in a standard way to playback audio messages stored within the memory of microprocessor 80. All audio components and microprocessor 80 are stored inside the main body 10 of the invention 100.

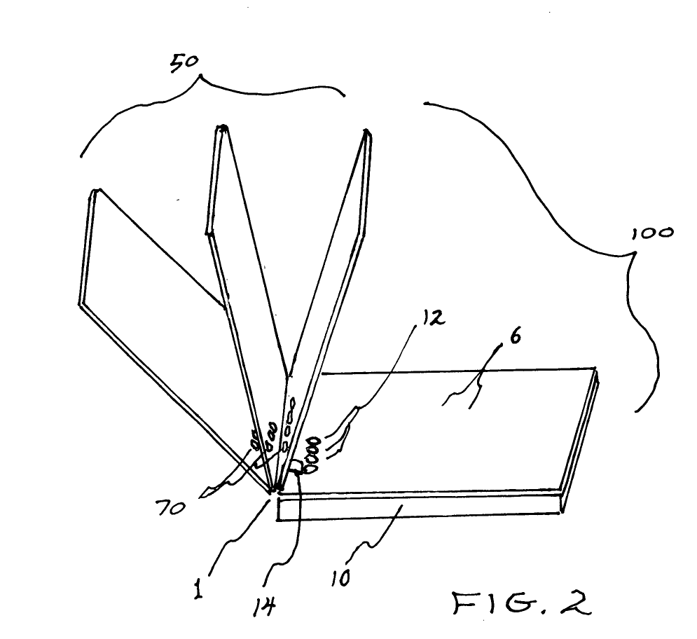

FIG. 2 shows a perspective view of the invention 100 with pages 50 opened, and main body 10 in view. The main body is a rectilinear housing 10. The top panel 6 of main body 10 includes apertures 12. The number of apertures 12 is equal to the number of pages 50 in the book. The pages 50 are made of rigid material and hinged 1 in a standard book format. The pages 50 also include apertures 70. There are a different number of apertures on each page. A light blocking panel 14 is fixed to the underside of each page so that when the page is closed, the panel 14 slides over and blocks an aperture 12 located on the main body top surface 6. Multiple light blocking panels 14 located under each page can block multiple apertures if necessary. When microprocessor 80 detects a new binary code generated by the presence or absence of light hitting the light sensing devices 13, the microprocessor knows which message to play for each individual page 50.

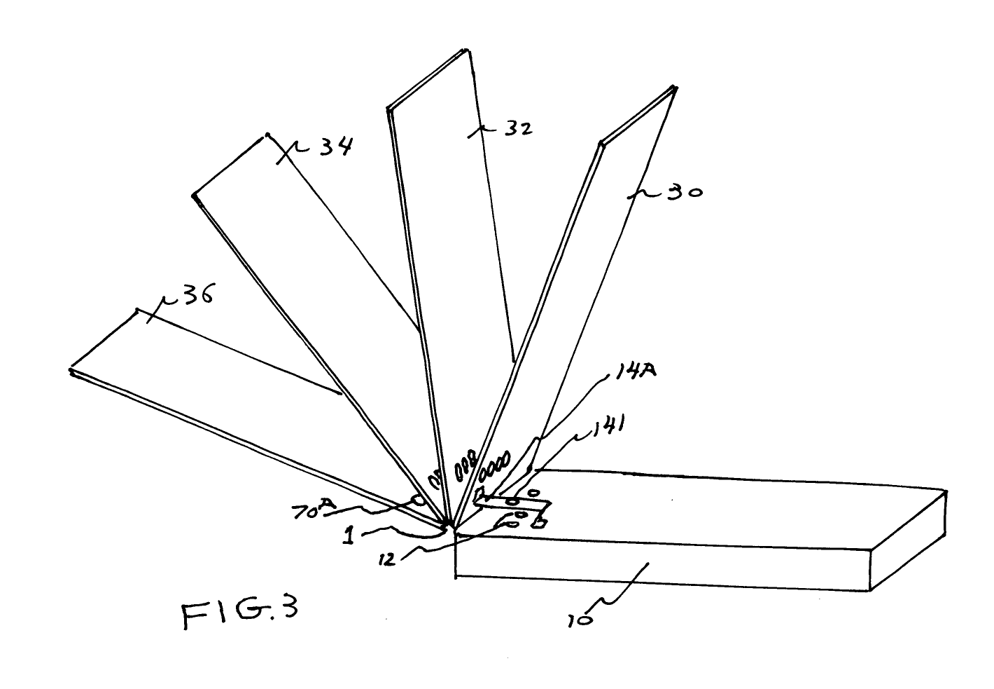

FIG. 3 shows a perspective view of an another embodiment of the invention 100 where the light blocking panel 14 includes an aperture 141 that aligns with the main body aperture 12 when the page is closed, but slides to the left when the page is opened, thereby causing the panel 14 to block the aperture 12 in the main body 10.

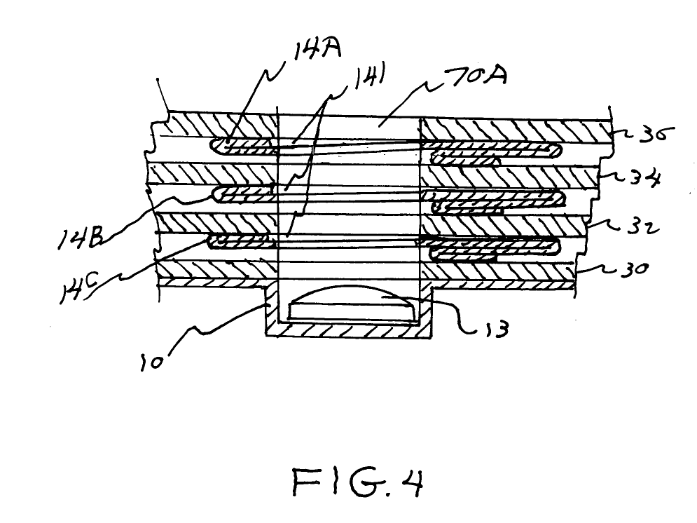

FIG. 4 shows a partial section view of the pages 50 and main body 10 where the page apertures 70, and main body apertures 12 occur. A light sensing device 13, such as a photo diode, is located under each aperture 12 and picks up the presence of absence of light depending on whether the aperture 12 is blocked by light blocking panel 14 or not. In this FIG. 4, the light blocking panels 14A, 14B, 14C include apertures 141 that allow light to pass through page apertures 70 in pages 30, 32, 34, and cover page 36 aperture 70A when the pages 50 of the book 100 are in the closed position. The presence or absence of light picked up by light sensors 13 are converted into electrical signals that are sent to trigger switches 3 as described above. The binary code formed by reading the presence or absence of light for each page lets the microprocessor 80 know what page 50 is being viewed so that the appropriate audio message can be played for that page without the user needing to press a playback button. For example if we were to assign the number “0” for open aperture and the number “1” for closed aperture, the light sensing devices 13 can detect aperture openings in the following way: All pages closed equals 1,1,1,1. Opening the first page equals 0,1,1,1. Turn to the second page equals 0,0,1,1. The third page equals 0,0,0,1 and the forth page equals 0,0,0,0. Up to four pages can be detected if there is only one aperture opening in each light blocking panel 14. And each light blocking panel is able to cover or uncover only one main body aperture 12. However, more than four pages can be detected if more than one light blocking panel 14 is installed under a page. For example, if the underside of page five has two adjacent light blocking panels 14 that can cover two adjacent apertures 12 located on the main body top 6, a binary code of “1100” can be achieved. This is a way to sense more than four pages while using the same number of apertures as described above. Additional pages can also be detected by adding additional apertures 12 in the main body top 6 and more corresponding light sensors 13 within the main body 10. Corresponding additional apertures in pages 50 can make longer binary codes to identify those additional pages. For example, page five can have five apertures and the main body can have 5 apertures 12 so that a code of “0,0,0,0,1” can be achieved. Another way to create additional binary codes is to provide an additional aperture 141 in a light blocking panel 14 and an additional row of apertures 12 and light sensing devices 13 in main body 10. The additional row of apertures 12 allows for many more binary code selections.

In the above described and illustrated way, the pages of an audio book can be recognized in a novel fashion by sensing the presence or absence of light created by open or closed apertures of book pages 50 and the main body 10. Other types of books can also use the above invention. For example, a photo album can include the above defined page identification system so that an appropriate message can be played for each page of photos displayed.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. a page identification method for audio book comprising:
a main rectilinear housing;
a plurality of rigid pages;
a plurality of light blocking panels;
a standard audio record and playback electronic circuit including microphone, speaker, power source;
a microprocessor;
a plurality of light sensing devices;
the top surface of said main body having a plurality of apertures;
each said light sensing device located directly under each said main body aperture;
each said page having one or more apertures;
each said page hingedly attached in standard book form to said main body;
each said page having at least one aperture that is aligned with at least one of said main body apertures;
each light blocking panel interleaved between each page ;
each said light blocking panel affixed at one edge to the underside of each said page so that when said page is turned by said user said light blocking panel slides over to cover or uncover said page aperture; and
said covering and uncovering of said page apertures causing said light sensing devices to send a signal to trigger switches within said microprocessor producing a binary coded signal that tells said microprocessor which message to play for each said page.

2. A page identification method for audio book as claimed in claim 1 wherein said light blocking panels each contain one or more apertures that assist in covering or uncovering said apertures in said main body and producing binary coded light sensing signals for telling said microprocessor which audio message to play for each said page.

3. A page identification method for audio book as claimed in claim one wherein more than one said light blocking panel can be interleaved between each said page to be able to cover more than one said light sensing device to produce additional said binary signals allowing additional pages to be identified by said microprocessor.
